(19) United States
(12) Patent Application Publication
(10) Pub. No.: US 2003/0182372 A1
(43) Pub. Date: Sep. 25, 2003

(54) Cyber-government system utilizing the internet network

(76) Inventor: Jae-Hak Lee, Kyunggi-Do (KR)

Correspondence Address: Frank Chau, F Chau & Associates, Suite 501, 1900 Hempstead Turnpike, East Meadow, NY, 11554, US

(21) Appl. No.: 10/362,782

(22) PCT Filed: Aug. 24, 2001
(86) PCT No.: PCT/KR01/01431

(30) Foreign Application Priority Data
Aug. 24, 2000 (KR) 200049093

(51) Int. Cl. G06F 15/16

(52) U.S. Cl. 709/204

(57) ABSTRACT

Disclosed herein is an Internet based cyber-nation system. The cyber-nation system comprises a host for operating and managing a computer under its control and supervising various surveys by request, a host server, users comprised a nonmember users and member users, and survey requesters requesting various surveys. The host server is comprised of cyber-government including all government organizations that conform to a political system and information thereof, a survey and determination system for performing various surveys and cyber-elections, a membership management system for managing the registration and withdrawal of members, and a utilization promotion system for granting cumulative scores to the users of the cyber-nation system in proportion to the number of visits to and activities in the cyber-nation system and awarding benefits to the users obtaining the predetermined number of accumulated scores.

### BACKGROUND OF THE INVENTION

1. Field of the Invention

The present invention relates, in general, to an Internet based cyber-nation system and, more particularly, to an Internet based cyber-nation system, which is capable of offering persons who desire to participate in politics, opportunities for participating in politics, providing a space for criticizing actual politics, and allowing various surveys of public opinion to be precisely and inexpensively performed.

2. Description of the Prior Art

As a society becomes complex and busy, individualism prevails, thereby gradually reducing the people's concern with politics. For example, in Korea, the turnout of voters in recent elections has decreased to about 50%.

Since politics is carried out by a small number of people due to the decrease of participation in politics, there occur many problems in which public opinion is not fully reflected in the action of politicians, the activities of government undergo many trials and errors, etc.

In order to overcome such problems, many non-government organizations (NGOs) have put pressure on the government while making an issue of the problems. These activities are often not effective and the influence of the NGOs is weak, so that it is difficult to solve the problems completely.

Meanwhile, various surveys of public opinion on various pending problems, policies, issues, etc. are performed frequently. However, in these surveys, since samples should be chosen from a population and various questions should be asked of the samples, such surveys are very inconvenient and consume excessive funds.

Additionally, there are a number of persons who cannot participate in politics for various reasons, though they are interested in politics and anxious to participate in politics. Furthermore, there is no effective way of providing them with opportunities to participate in politics easily.

### SUMMARY OF THE INVENTION

Accordingly, the present invention has been made keeping in mind the above problems occurring in the prior art, and an object of the present invention is to provide an Internet based cyber-nation system, which is capable of offering persons who desire to participate in politics, opportunities for participating in politics, providing a space for criticizing actual politics, and allowing various surveys of public opinion to be precisely and inexpensively performed.

In order to accomplish the above object, the present invention provides an Internet based cyber-nation system, comprising: a host for operating and managing a computer under its control and supervising various surveys by request; a host server comprised of cyber-government including all government organizations that conform to a political system and information thereof, a survey and determination system for performing various surveys and cyber-elections, a membership management system for managing the registration and withdrawal of members, and a utilization promotion system for granting cumulative scores to the users of the cyber-nation system in proportion to the number of visits to and activities in the cyber-nation system and awarding benefits to the users obtaining the predetermined number of accumulated scores; users comprised of nonmember users and member users; and survey requesters requesting various surveys that are performed using the cyber government.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of an Internet based cyber-nation system in accordance with the present invention.

### DESCRIPTION OF THE PREFERRED EMBODIMENTS

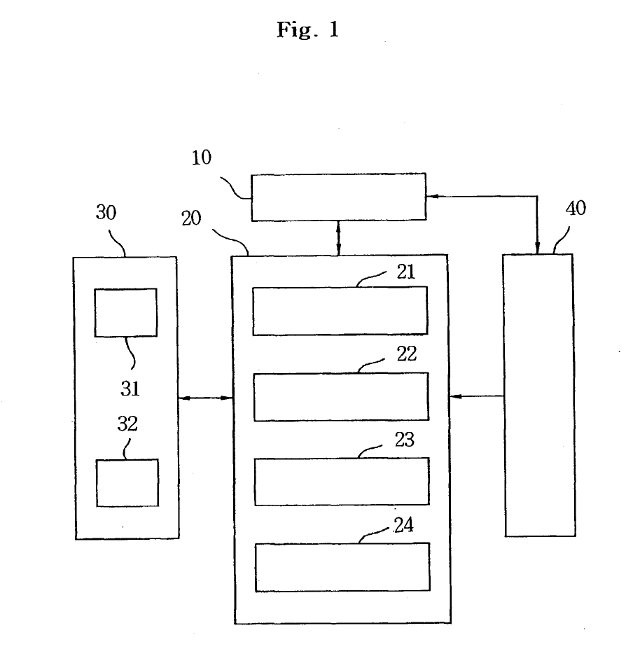

FIG. 1 is a block diagram showing the construction of an Internet based cyber-nation system in accordance with the present invention.

An Internet based cyber-nation system includes a host 10 for operating and managing a computer under its control and supervising various surveys by request. The cyber-nation system further includes a host server 20. The host server 20 is comprised of cyber-government 21 including all government organizations that conform to a political system and related information, a survey and determination system 22 for performing various surveys and cyber-elections, a membership management system 23 for managing the registration and withdrawal of members, and a utilization promotion system 24 for granting cumulative scores to the users of the cyber-nation system in proportion to the number of visits to and activities in the cyber-nation system and awarding benefits to the users obtaining the predetermined number of accumulated scores or more. In addition, the cyber-nation system includes users 30 comprised of nonmember users 31 and member users 32 and survey requesters 40 requesting various surveys that are performed using the cyber-government 21.

In the cyber-government 21, all government organizations and information thereof are classified into the administration, the legislature and the judiciary, and the above-classified organizations and information thereof are systematically arranged in hierarchical order.

The leaders and constituents of government organizations of the cyber-government 21 are appointed or elected from all the member users 32 by all the users 30 including the nonmember users 31 and the member users 32. In its early stages, the leaders and constituents of government organizations are appointed from the member users 32 in the order of receipt. Within a predetermined period of time, the leaders and to constituents are elected from all the member users 32 by all the users 30 including the nonmember users 31 and the member users 32.

The nonmember users 31 freely access the cyber-nation system, state their opinions and are granted voting rights. On the other hand, the member users 32 are given their identification numbers and passwords, perform their duties of their own accords or according to the host's directions when they are constituents and are granted voting rights and electoral eligibilities.

The cyber-government 21 may be provided with electronic bulletin boards. The electronic bulletin boards are classified into an electronic bulletin board for the nonmember users 31 and an electronic bulletin board for the member users 32. The electronic bulletin board for the member users 32 is utilized for the duty directions and the duty reports.

When a survey requester 40 requests the host 10 to perform a survey while providing information relating to the survey with the host 10, the host 10 draws up a questionnaire on the basis of the information relating to the survey. The survey and determination system 22 provides all the users 30 with the questionnaire, classifies the survey results by sex, age, vocation, residence, etc., and maces out the statistics of the survey.

The membership management system 23 manages information relating to the registration and withdrawal of members. The membership management system 23 stores the personal information of the member users 32, and grants authority to and imposes responsibility upon the users 30 according to the qualification of the users 30.

In order to promote the utilization of the cyber-nation system according to the present invention, the utilization promotion system 24 grants cumulative scores to the users of the cyber-nation system in proportion to the number of visits to and activities in the cyber-nation system. Thereafter, the utilization promotion system 24 awards benefits, such as premiums, free coupons or discount coupons, to the users obtaining the predetermined number of accumulated scores or more.

In its early stages, the host server 10 receives applications for the positions of leaders and constituents of government organizations from the users 30, evaluates the applicants, and appoints the member users 32 to their positions in the order of receipt. The appointed member users 32 constitute and operate an interim cyber-government.

Within a predetermined period of time, the leaders and constituents of the organizations of the cyber-government 21 are elected from all the member users 32 by all the users 30 including the nonmember users 31 and the member users 32. The elected leaders and constituents operate the cyber-government 21 in cyberspace.

In the cyber-election, each of the users 30 is granted a single voting right. In the case of electing the leaders of local self-governing organizations, only nonmember users 31 and member users 32 who actually reside in a related region are granted voting rights.

The term of cyber-election is preferably identical to that of actual election. However, the date of election preferably will fall in the midst of the term of actual elections so as to prevent the cyber-election from being confused with the actual election and from affecting the actual election.

The elected leaders and constituents carry out a variety of policies and plans that have been performed and will be performed by actual government and are proposed by the leaders and constituents themselves, in the cyberspace. The opinions of the users 30 on the policies and plans may be reflected in the policies and plans.

In addition, the leaders or constituents collect the opinions of the users 30 on the policies and plans that have been performed and will be performed by actual government and state these opinions in a public hearing, thereby causing public opinions to be reflected in actual politics.

After the cyber-nation is operated for a predetermined period of time, some of the member users 32 are allowed to run for election and the users 30 are allowed to evaluate their political views and policies and elect leaders and constituents of the organizations of the cyber-government 21, so that the mandate of leaders and constituents can be renewed periodically through the election by the users 30.

In the above described process, cumulative scores are granted by the utilization promotion system 24 to the users 30 of the cyber-nation system in proportion to the number of visits to and activities in the cyber-nation system, benefits, such as premiums, free coupons or discount coupons, are awarded by the utilization promotion system 24 to the users obtaining the predetermined number of accumulated scores or more, and the scores are subtracted from the accumulated scores, thereby inducing the participation in the cyber-nation system and maintaining users' interest in the cyber-nation system.

As described above, the present invention provides an Internet based cyber-nation system, which is capable of offering persons who desire to participate in politics, opportunities for participating in politics, providing a space for criticizing actual politics, and allowing various surveys of public opinion to be precisely and inexpensively performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An Internet based cyber-nation system, comprising:
a host for operating and managing a computer under its control and supervising various surveys by request;
a host server comprised of,
cyber-government including all government organizations that conform to a political system and information thereof,
a survey and determination system for performing various surveys and cyber-elections,
a membership management system for managing the registration and withdrawal of members, and
a utilization promotion system for granting cumulative scores to the users of the cyber-nation system in proportion to the number of visits to and activities in the cyber-nation system and awarding benefits to the users obtaining the predetermined number of accumulated scores;
users comprised of nonmember users and member users; and
survey requesters requesting various surveys that are performed using the cyber government.

2. The cyber-nation system according to claim 1, wherein said cyber-government includes all government organizations and related information that are systematically arranged in hierarchical order.

3. The cyber-nation system according to claim 1, wherein when said survey requester requests the host to perform a survey while providing information relating to the survey with the host, said host draws up a questionnaire on the basis of the information relating to the survey, and said survey and determination system provides all the users with the questionnaire, classifies the survey results by sex, age, vocation, residence, etc. and makes out the statistics of the survey.

4. The cyber-nation system according to claim 1, wherein said utilization promotion system distinguishes between the nonmember users and the member users and awards different benefits respectively to the nonmember users and the member users.

5. The cyber-nation system according to claim 1, wherein said utilization promotion system grants cumulative scores to the users in proportion to the number of visits to and activities in the cyber-nation system, and awards benefits, such as premiums, free coupons or discount coupons, to the users obtaining the predetermined number of accumulated scores or more.
